(19) United States
(12) Patent Application Publication
(10) Pub. No.: US 2026/0149690 A1
(43) Pub. Date: May 28, 2026

(54) NETWORK-BASED INTERNET-OF-THINGS DEVICE INVENTORY SYSTEM

(71) Applicant: Cisco Technology, Inc., San Jose, CA (US)

(72) Inventors: Robert E. BARTON, Richmond (CA); Ashok HEGDE, Konanakunte Cross (IN); Srinivasa Rao NALLURI, Akshaya Nagar East (IN); Saravanan M KARUNANIDHI, Bangalore (IN); Priyanka BANSAL, Bengaluru (IN)

(21) Appl. No.: 18/962,354

(22) Filed: Nov. 27, 2024

(51) Int. Cl. H04L 67/125; G06Q 10/087; H04L 67/10

(52) U.S. Cl. CPC H04L 67/125; G06Q 10/087; H04L 67/10

(57) ABSTRACT

In one embodiment, a method for a network-based Internet-of-Things device inventory system includes forming, by a process, a dedicated multicast group comprising a plurality of network devices that support an asset discovery protocol and receiving, by the process, a query comprising a series of descriptors corresponding to features associated with one or more network devices among the plurality of network devices. The method further includes executing, by the process, the query within the dedicated multicast group and generating, by the process, a report comprising specific details associated with the one or more network devices among the plurality of network devices in response to executing the query and based on the asset discovery protocol.

### TECHNICAL FIELD

The present disclosure relates generally to computer networks, and, more particularly, to a network-based Internet-of-Things device inventory system.

### BACKGROUND

Operational technology (OT) networks typically support the connectivity of multiple Internet-of-Things (IoT) devices, such as intelligent electronic devices (IEDs), programmable logic controllers (PLCs), human machine interfaces (HMIs), sensors, variable air volume (VAV) systems, and so on and so forth. These devices are often deployed at large scale and can be distributed over a large area. As a result, inventory management of these and other devices in OT networks can present a significant challenge for OT network operators.

In an effort to alleviate these challenges, various approaches to inventory management in OT networks have been presented. In general, these approaches can include OT asset management systems, OT network security systems, etc. However, many of these approaches can require complex and/or expensive management tools that typically rely on multi-step discovery methodologies, such as ping sweeps, analysis of NetFlow logs, and/or other such discovery methodologies. Still other approaches to inventory management in OT networks can rely on vendor-specific or proprietary systems that may not be able to interface with devices in the OT network that are provided by different vendors.

As a result of these approaches generally providing complex and/or expensive management tools or proprietary solutions, adoption of these and other approaches to inventory management in OT networks has been hindered. For example, the associated costs and operational complexity of these approaches to inventory management in OT networks appear to hinder wide-scale adoption of OT network inventory management systems, particularly for smaller-scale operations (e.g., smaller businesses).

Further, in scenarios where OT networks span remote locations, operators commonly rely on cellular connections to link access networks with backend systems. The necessity to regularly update a centralized inventory via these cellular connections can incur additional, ongoing operational expenses.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example architecture for a network-based Internet-of-Things device inventory system; and

FIG. 4 illustrates an example procedure for a network-based Internet-of-Things device inventory system.

### DESCRIPTION OF EXAMPLE EMBODIMENTS

### Overview

According to one or more embodiments of the disclosure, a method for a network-based Internet-of-Things device inventory system includes forming, by a process, a dedicated multicast group comprising a plurality of network devices that support an asset discovery protocol and receiving, by the process, a query comprising a series of descriptors corresponding to features associated with one or more network devices among the plurality of network devices. The method further includes executing, by the process, the query within the dedicated multicast group and generating, by the process, a report comprising specific details associated with the one or more network devices among the plurality of network devices in response to executing the query and based on the asset discovery protocol.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

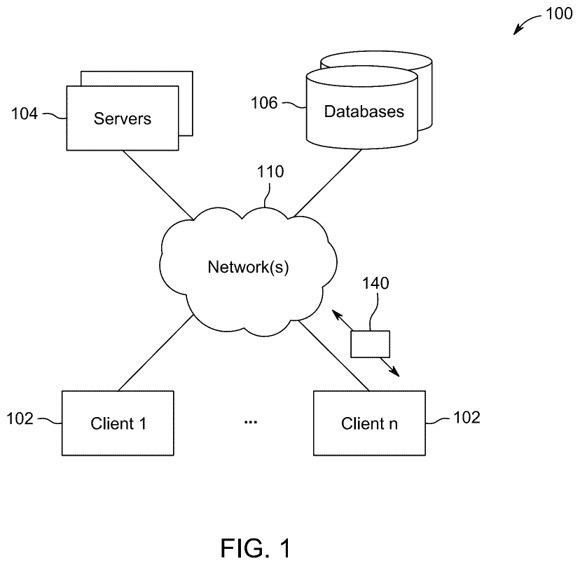

FIG. 1 is a schematic block diagram of an example simplified computing system (e.g., computing system 100) illustratively comprising any number of client devices (e.g., client devices 102, such as a first through n^{th} client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet-of-Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some embodiments, the techniques herein may be applied to other network topologies and configurations, particularly to operational technology (OT) networks, as described below. For example, the techniques herein may be applied to peering points with high-speed links, data centers, etc.

In various embodiments, computing system 100 (e.g., a network) may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet-of-Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

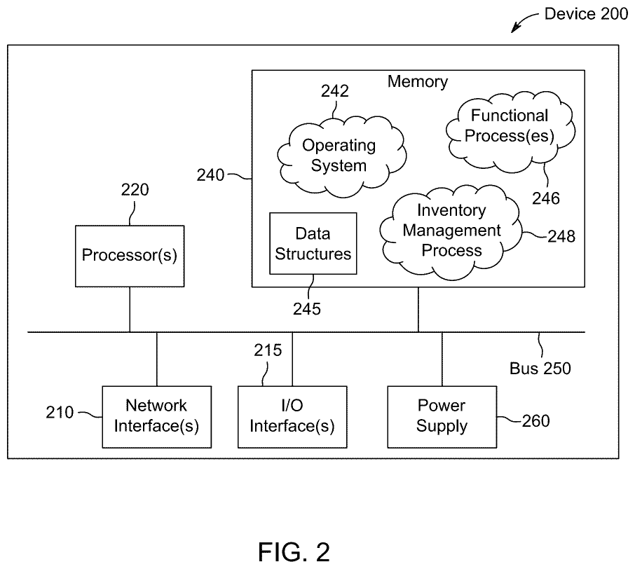

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an inventory management process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, one or more functional processes 246 and/or inventory management process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Network-Based Internet-of-Things Device Inventory System

Industrial asset discovery (IAD) is a discovery mechanism used by various operating systems in conjunction with industrial ethernet switches. IAD can learn about devices using a wide variety of discovery protocols such as Cisco Discovery Protocol (CDP), Link Layer Discovery Protocol (LLDP), as well as specialized OT protocols including Common Industrial Protocol (CIP), PROFINET, MODBUS, and others. Currently, IAD can collect device information, including the manufacturer, model, firmware version, etc. Using current approaches to IAD, the edge switch maintains a local database of all attached devices which can be exported for the use of other network management platforms. In such current approaches, IAD refreshes its database regularly on each switch interface.

As will be appreciated, some of the aforementioned protocols, such as CDP and LLDP, have been utilized for years, allowing a switch or router to discover directly connected devices. However, these protocols may be limited to devices that actually support these protocols. Over time, it is predicted that IAD will be expanded with more discovery and profiling mechanisms.

As noted above, OT networks generally support IoT devices, such as IEDs, PLCs, HMIs, VAV systems, and/or sensors, etc. These devices can be deployed on a large scale and/or geographical area and, as a result, can present a significant challenge for OT network operators, particularly with respect to inventory management of these and other devices in OT networks.

To alleviate these challenges, current approaches to inventory management in OT networks can include OT asset management systems, OT network security systems, and/or proprietary solutions, etc. However, these approaches can require complex and/or expensive management tools that typically rely on multi-step discovery methodologies, such as ping sweeps, analysis of NetFlow logs, and/or other such discovery methodologies, as well as proprietary and/or vendor-specific solutions—all of which have hindered the adaptation of inventory management systems in OT networks on a wide-scale. Given these challenges, there is a pressing need for a more streamlined and cost-effective approach to OT inventory management that capitalizes on the inherent capabilities of the network infrastructure.

The techniques herein therefore provide for a simplified and efficient means of managing OT assets. More specifically, the techniques described herein contemplate systems that can provide industrial asset discovery (IAD) for network devices that are deployed in a distributed computing network, such as on OT network. In contrast to previous approaches that merely rely on centralized network management station (NMS) inventory management systems, implementations described herein can allow for edge devices (e.g., edge switches, edge nodes, etc.) and/or routers in the OT network to act as a distributed IAD database.

As described in more detail herein, aspects of the present disclosure allow for distributed inventory collection, and, hence, IAD for network devices in a manner that is linked to create a unified and distributed database that overcome the issues present in current approaches. For example, aspects of the present disclosure may utilize specialized types of multicast queries (e.g., specialized multicast queries to a dedicated multicast group of devices in an OT network) that allow for collection of information related to particular devices in the network. Further, such specialized types of multicast queries can include granular selection criteria, further allowing for collection of information related to only particular devices in the network that meet such criteria, and thereby improving IAD when compared to current approaches.

In contrast to approaches that rely on a centralized inventory management system, which therefore generally require that a complete network topology has been learned and maintained, along with the centralized database of inventory being maintained at a central location, both of which add to the complexity of the system, implementations herein can allow for distributed inventory collection, thereby alleviating issues in current approaches.

Further, approaches that rely on a centralized management system can also require constant polling to keep the database up to date and can experience constraints where inventory collection may need to happen over a constrained environment such as a cellular link. In contrast, implementations described herein that employ a distributed inventory system, where data from various devices in the network may be fetched on an ad hoc basis, can avoid these issues as well, thereby providing an improved experience in resource constrained computing environments. Moreover, implementations described herein may be managed using a “simple” controller (e.g., a processing device that requires a relatively small amount of computing resources to operate), as opposed to a powerful controller (e.g., a rack controller or similar computing resource intensive processing unit) that may be associated with a centralized management system.

In addition, implementations herein provide mechanisms in which a network manager can easily leverage IAD from anywhere in the network, giving the network manager quick and easy discovery, monitoring, and inventory management of all connected devices. Moreover, implementations herein can provide a network manager with the ability to quickly and easily build an on-demand report of all relevant OT devices using a simple network inventory tool.

Specifically, according to one or more embodiments of the disclosure as described in detail below, a method for a network-based Internet-of-Things device inventory system includes forming, by a process, a dedicated multicast group comprising a plurality of network devices that support an asset discovery protocol and receiving, by the process, a query comprising a series of descriptors corresponding to features associated with one or more network devices among the plurality of network devices. The method further includes executing, by the process, the query within the dedicated multicast group and generating, by the process, a report comprising specific details associated with the one or more network devices among the plurality of network devices in response to executing the query and based on the asset discovery protocol.

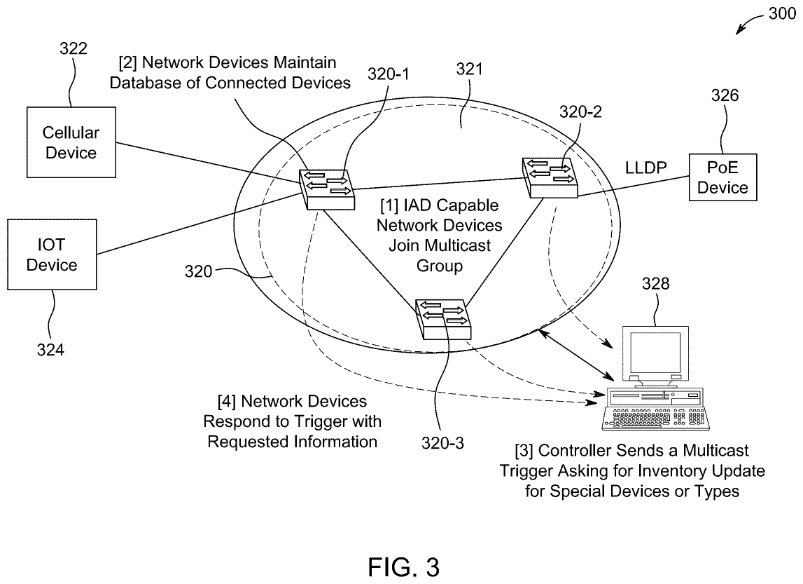

Operationally, FIG. 3 illustrates an example architecture for a network-based Internet-of-Things device inventory system. The architecture 300 (which can be referred to in the alternative as a “system” or “apparatus”) can include a multicast group 321, which can include a plurality of network devices, e.g., a first network device 320-1, a second network device 320-2, and a third network device 320-3 (which can be referred to herein collectively as “network devices 320.”). The network devices 320 can be network switches, routers, or other IAD enabled network devices. It will be appreciated that a greater quantity or a lesser quantity of network devices are contemplated within the disclosure and the illustrative example of FIG. 3, in which three enumerated network devices are shown is not intended to limit the scope of the disclosure.

As shown in FIG. 3, the first network device 320-1, the second network device 320-2, and the third network device 320-3 can be associated with the multicast group 321. The multicast group 321 can be a dedicated multicast group that includes multiple network devices (e.g., the network devices 320) that can support industrial asset discovery in accordance with various asset discovery protocols.

As shown in FIG. 3, one or more of the network devices can be communicatively coupled to a cellular device 322, an IoT device 324, a power over ethernet device (e.g., POE device 326), or other devices not explicitly shown in the example of FIG. 3. In addition, a network controller 328 can be included in the system. In some implementations, the network controller 328 can handle various commands, instructions, and/or tasks associated with controlling the system of FIG. 3 and/or the multicast group 321.

The cellular device 322 can be a smartphone, phablet, tablet, laptop, or other type of user device that can connect to a network via one of the network devices 320. For simplicity, the cellular device 322 of FIG. 3 is communicatively coupled to the first network device 320-1, although implementations are not so limited.

The IoT device 324, which can be any type of IoT device (e.g., any piece of hardware, such as sensors, actuators, gadgets, appliances, or machines, that are programmed for certain applications and can transmit data over the internet or other networks) may also be communicatively coupled to a network via one of the network devices 320. In some implementations, the IoT device 324 can be coupled to a network device via a Process Field Network (PROFINET) connection, a Common Industrial Protocol (CIP) connection, or other suitable connection. For simplicity, the IoT device 324 of FIG. 3 is communicatively coupled to the first network device 320-1, although implementations are not so limited.

The POE device 326 can be any type of POE device, such as LED lighting and sensors, cameras, thin client computers, VoIP phones, IP security cameras, facility monitoring controls, digital signage, point of sale kiosks, intercoms, security card readers, etc. The POE device 326 may be communicatively coupled to the network via a Link Layer Discovery Protocol (LLDP), or other suitable protocols, although implementations are not so limited.

The network controller 328 can be communicatively coupled to the multicast group 321 and can control sending of commands and/or instructions to the network devices 320 that are part of the multicast group 321 to facilitate implementations of the disclosure. The network controller 328 can be a network controller that can manage the devices that are part of the multicast group 321 (e.g., the network devices 320, the cellular device 322, the IoT device 324, the POE device 326, etc.). In some implementations, the network controller 328 can utilize artificial intelligence to connect, secure, and/or automate network operations described herein. Implementations are not so limited, however, and the network controller 328 can, in accordance with the disclosure, accept inputs from users of the system to facilitate the techniques described herein.

As described in more detail herein, at operation [1], IAD capable network devices (e.g., the first network device 320-1, the second network device 320-2, and the third network device 320-3) can join a multicast group, such as the multicast group 321. In some implementations, the multicast group 321 can be a “dedicated multicast group” that is formed with IAD capable network devices for the purpose of exchanging inventory management information regarding devices within the architecture 300.

For example, operation [1] can involve initializing a dedicated multicast group for asset inventory communication, i.e., a dedicated multicast group that can receive specialized types of multicast queries (e.g., specialized multicast queries directed to the dedicated multicast group of devices in an OT network) that allow for collection of information related to particular devices in the architecture 300.

In such implementations, the network devices 320 (e.g., industrial ethernet switches and other networking devices, including industrial Wi-Fi access points (APs), or other such network devices) that support IAD join the dedicated multicast group (e.g., the multicast group 321). The multicast group 321 can then be used for asset inventory communication, as described herein. In some implementations, the multicast group 321 can be used explicitly for trigger-based information and/or status pulls from a network management station, (e.g., the network controller 328) to obtain details from all of the network devices 320 that are connected to a device (e.g., an “asset”) that matches a series of descriptors, or “criteria,” corresponding to features associated with one or more of the devices/assets that are requested as part of a trigger-based information and/or status pull.

At operation [2], the network devices 320 can each maintain a database of devices that are connected to a particular network device. For example, the first network device 320-1 can maintain a database of devices (e.g., the cellular device 322, the IoT device 324, the POE device 326, etc.) that are connected to the first network device 320-1, the second network device 320-2 can maintain a database of devices that are connected to the second network device 320-2, and so on and so forth. These databases can include inventory asset management information corresponding to the devices connected to the network devices 320, as discussed in more detail below.

For example, operation [2] can involve network inventory management (e.g., IAD management) for flexible handling of queries based on the series of descriptors, or “criteria” discussed herein. In some implementations, a network inventory workstation or multiple network inventory workstations can be provided to carry out the operations described herein. The network controller 328 may serve as such a workstation or may be one of such workstations, although implementations are not so limited. In accordance with the disclosure, the network inventory workstation(s) can be accessed via a software application that may provide a graphical user interface (GUI) or simply via a command prompt interface. Several non-limiting examples of software applications, GUIs, and/or command-line tools that operate on a command prompt interface can include IoT Operations Dashboard by Cisco®, and Secure Equipment Access (SEA) by Cisco®, among other software applications, GUIs, and/or command-line tools that allow a network operator the ability to monitor and/or provide instructions to the network devices 320.

At operation [2], a network operator may wish to collect specific asset inventory information from the network (i.e., the architecture 300). In this scenario, all of the network devices 320 can be part of the multicast group 321 and can therefore respond to a dedicated multicast query that is sent to the multicast group 321.

In accordance with the disclosure, the network operator (or other relevant party) can then input a series of descriptors corresponding to features associated with one or more network devices of interest. The series of descriptors may include any features and/or any combination of features associated with the network devices in the system. Non-limiting examples of such features that may be included in the series of descriptors can include:
Show me all the IP cameras in the network for Security Management to ensure all cameras are functional and no unauthorized devices are connected.
Show me all Apple devices in the network for Policy Compliance to ensure only approved devices are connected to the network.
Show me all Apple+Samsung devices in the network for Security Assessment to check if any devices need security patches or pose a potential vulnerability.
Show me all PLCs and HMIs that are in Level 2, Area/Zone C for Operational Oversight or Safety and Compliance to ensure that critical control systems are functioning correctly and meet safety regulations.
Show me all the devices which were added in the last 24 hours for Incident Response to identify potential unauthorized access or security breaches by spotting new, unexpected devices.
Show me all the PoE devices and their current power consumption for Infrastructure Planning to ensure the network infrastructure can support the power requirements of connected devices.

It will be appreciated, however, that the foregoing examples of descriptors are not intended to be limiting to the disclosure and other descriptors, combinations of descriptors, and descriptors directed to other features of devices in the network are contemplated herein. In general, implementations of the disclosure seek to provide a system that allows for flexible (e.g., on demand and specified) descriptors that can be provided as a query to the multicast group 321. This can allow for the network devices 320 to respond to the network controller 328 with only the information relevant to a query based on the descriptors, thereby providing a more streamlined and less resource intensive methodology for IAD in comparison to previous approaches.

It is noted that, in accordance with the disclosure, different multicasts groups can be formed, particularly at various levels of the OT network. For example, some network devices may operate at different levels of the OT network and these network devices can be grouped into the dedicated multicast groups described herein. In addition, or in the alternative, some network devices can be grouped into multiple multicast groups at different levels of the OT network in accordance with the disclosure.

Further, various security controls can be implemented for any device in the system to reduce the risk of nefarious actors impeding the operation of the system. For example, security controls to protect against denial-of-service (DoS) attacks, such as distributed denial-of-service (DDoS) attacks can be implemented in accordance with the disclosure. Non-limiting examples of such protections can include rate limiting of central processing units (CPUs) of IAD services on the network devices 320 and/or implementation of encryption mechanisms for the multicast group 321 (or any additional dedicated multicast groups formed in accordance with the disclosure).

At operation [3], the network controller 328 can sends a multicast message (e.g., a multicast trigger) to the network devices 320 in the multicast group 321 asking for an inventory update for devices and/or device types that are part of the architecture 300. In some implementations, these devices and/or device types can be edge devices (e.g., edge switches, edge nodes, etc.) and/or routers in the OT network, such as the cellular device 322, the IoT device 324, the POE device 326, etc.). The multicast message sent by the network controller 328 can be a specialized multicast query that allows for collection of information related to particular devices in the network and can, accordingly, be a specialized multicast query that can include granular selection criteria—that can be controlled by, for example, a user—that pinpoint particular devices in the network that meet such criteria.

For example, operation [3] can involve performance of one or more distributed IAD database querying operations. These operations can include execution of a query, by the network controller 328, to the entire network (i.e., to the multicast group 321). Each of the network devices 320 that are part of the multicast group 321 receive the query and decode the query. The network devices 320 can then examine their local IAD databases (which can be current up to the minute or less) to determine if there is information in the local databases that is relevant to the query.

At operation [4], the network devices 320 can respond to the multicast message of operation [3]. In some implementations, the network devices 320 can respond to the multicast message with a multicast message directed at the network controller 328 and/or the network devices 320 can respond with various unicast messages to the network controller 328. The response from the network devices 320 can include information dictated by the granular selection criteria provided in the multicast message sent by the network controller 328 at operation [3].

For example, operation [4] can include providing an intelligent device response to the query of operation [3]. Based on the descriptors in the query, the network devices 320 can generate reports that can be sent back to the network controller 328. In some implementations, the query can include, in addition to descriptions of which assets are to be reported on, requests for specific details pertaining to those assets. Non-limiting examples of such specific details pertaining to the assets can include:
Details of the device type
IP address
MAC address
Firmware version
Length of time the device has been connected to the network
   and so on and so forth. This utilization of a set of flexible, user-defined constraints in the query can allow for only the information that is requested in the query to be returned to the network operator via the network controller 328.

It is noted that, in contrast to current approaches, which rely on a centralized inventory management system, the implementations described herein allow for the network itself (e.g., the network devices themselves) to maintain inventory information using a distributed IAD database on every network node. Accordingly, a mechanism to build unified inventory reports based on the distributed IAD inventory system is disclosed herein.

In some implementations, the system can be continuously monitored by performing the operations described above at pre-configured intervals and/or on an ad hoc basis. For example, the network operator can cause the network controller 328 to repeat a same query at pre-configured time intervals in order to maintain an up-to-date inventory of the devices in the network that have characteristics that meet the descriptors in the query. In addition to, or in the alternative, the network operator may make adjustments or modifications to the query and cause the query to be sent to the multicast group 321 at any time.

In implementations where the network controller 328 is configured to re-send the query at pre-configured time intervals, the network controller 328 may encounter a scenario in which one or more of the network devices 320 fails to respond to the query (e.g., one or more of the network devices 320 does not return a unicast message to the network controller 328 in response to the multicast query sent by the network controller 328). In this case, the network controller 328 can re-send the query as a unicast message to only the network device(s) that failed to respond to the multicast query.

In the event that the network device(s) fails to respond to the unicast query, it can be assumed that that particular network device is no longer in the network and that particular network device can be removed from the network. On the other hand, if that particular network device responds to the unicast query, it can be assumed that the multicast query to that particular network device was lost somewhere in the network and appropriate troubleshooting mechanisms may be employed.

In other implementations, the IAD history can be stored in a database associated with network devices that are plugged into each port of a network switch. In these implementations, the switch may be configured to return a historical IAD report when queried. Further, in some implementations, the system can be configured to learn from previous queries and may optimize subsequent command distributions to improve the efficiency of the system. It will be appreciated that, in such implementations, the system can employ various machine learning and/or artificial intelligence techniques in order to learn from the previous queries to optimize the subsequent command distributions.

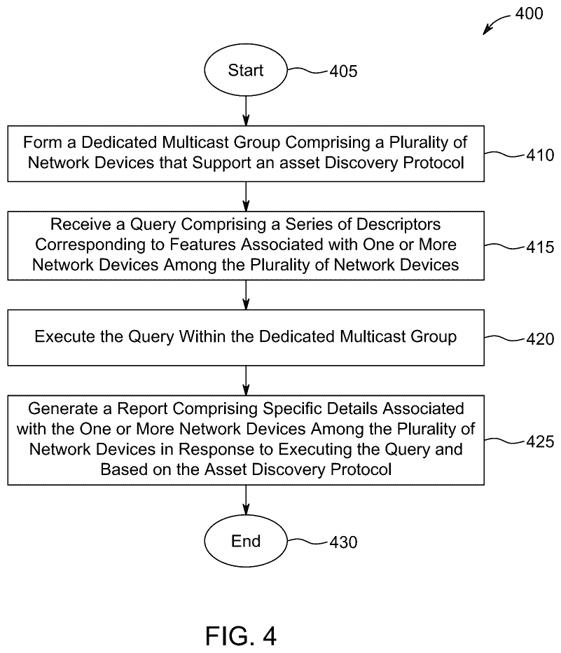

In closing, FIG. 4 illustrates an example simplified procedure for a network-based Internet-of-Things device inventory system in accordance with one or more embodiments described herein, particularly from the perspective of a device. For example, a non-generic, specifically configured device (e.g., device 200, an apparatus) may perform procedure 400 by executing stored instructions (e.g., process 248). The procedure 400 may start at step 405, and continues to step 410, where, as described in greater detail above, a process forms a dedicated multicast group comprising a plurality of network devices that support an asset discovery protocol. In some implementations, the asset

discovery protocol can be an industrial asset discovery protocol. Further, in some implementations, each network device among the plurality of network devices can maintain a localized industrial asset discovery database, as discussed above.

The procedure 400 continues to step 415 where, as discussed in greater detail above, the process receives a query comprising a series of descriptors corresponding to features associated with one or more network devices among the plurality of network devices. In some implementations, the series of descriptors may comprise descriptors selected for a list consisting of: security management protocols; policy compliance protocols; security assessment protocols; operational oversight protocols; safety and compliance protocols; security breach protocols; and power consumption protocols, among other descriptors.

The procedure 400 continues to step 420 where, as discussed in greater detail above, the process executes the query within the dedicated multicast group.

The procedure 400 continues to step 425 where, as discussed in greater detail above, the process generates a report comprising specific details associated with the one or more network devices among the plurality of network devices in response to executing the query and based on the asset discovery protocol. In some implementations, the specific details in the report may comprise only specific details that are relevant to the series of descriptors included in the query. That is, in some implementations, the specific details can be only details or information that is requested as part of the query and may not include other details that are not specifically enumerated in the query. Further, in some implementations, the procedure 400 can include generating, by the process, the report for only those network devices among the plurality of network devices that match a particular set of criteria corresponding to the series of descriptors.

In some implementations, the procedure 400 can include decoding, by each of the plurality of network devices that receive the query, the query and performing, by each of the plurality of network devices that receive the query, a local industrial asset discovery database examination as part of generating the report. That is, in response to receiving the query, each of the network devices can decode the query locally and then search their respective local databases for information corresponding to the query to generate the report.

In some implementations, the procedure 400 can include determining, by the process, that a particular network device among the plurality of network devices did not respond to the query and sending, by the process and to the particular network device, a unicast query to determine a status associated with the particular network device. In such implementations, the procedure 400 can further include determining, by the process, that a response from the particular network device to the unicast query is not received and removing the particular network device from the dedicated multicast group in response to the response to the unicast query being not received. Implementations are not so limited, however, and in some implementations, the procedure 400 can further include determining, by the process, that a response from the particular network device to the unicast query has been received and maintaining the particular network device in the dedicated multicast group in response to the response to the unicast query being received.

As discussed herein, in some implementations, the procedure 400 can further include analyzing, by the process, previously submitted queries to determine trends in reports generated in response to the previously submitted queries and optimizing, by the process, command distributions associated with subsequent queries based, at least in part, on analysis of the trends in the reports generated in response to the previously submitted queries. Such analysis can be performed using machine learning and/or artificial intelligence algorithms, and/or may be performed with the assistance of various models, such as a large language model.

Procedure 400 may end at step 430.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: forming a dedicated multicast group comprising a plurality of network devices that support an asset discovery protocol; receiving a query comprising a series of descriptors corresponding to features associated with one or more network devices among the plurality of network devices; executing the query within the dedicated multicast group; and generating a report comprising specific details associated with the one or more network devices among the plurality of network devices in response to executing the query and based on the asset discovery protocol.

In still other implementations, a tangible, non-transitory, computer-readable medium storing program instructions that cause a device to execute a process comprising: forming a dedicated multicast group comprising a plurality of network devices that support an asset discovery protocol; receiving a query comprising a series of descriptors corresponding to features associated with one or more network devices among the plurality of network devices; executing the query within the dedicated multicast group; and generating a report comprising specific details associated with the one or more network devices among the plurality of network devices in response to executing the query and based on the asset discovery protocol.

The techniques described herein, therefore, provide for a network-based Internet-of-Things device inventory system. As described above, implementations herein can allow for distributed inventory collection, and, hence, IAD for network devices in a manner that is linked to create a unified and distributed database that overcome the issues present in current approaches. These and other features of the present disclosure can be realized via specialized types of multicast queries to a dedicated multicast group of devices in an OT network that allow for collection of information related to particular devices in the network. Further, such specialized types of multicast queries can include granular selection criteria, further allowing for collection of information related to only particular devices in the network that meet such criteria, and thereby improving IAD when compared to current approaches.

Further, the techniques described herein can allow for decentralization of IAD by maintaining a local IAD database on each network device. This can allow for a reduction in system overhead and reliance on a central inventory management system. In addition, the techniques herein can provide scalability because the use of multicast groups for querying allows the mechanism to scale efficiently as the network grows. The techniques herein can also improve efficiency of IAD system because only the requested information is returned to the operator, thereby reducing unnecessary data transmission and processing, particularly over LTE links. Moreover, the techniques herein can provide flexibility to network operators by allowing network operators to tailor queries to specific needs using a range of descriptors, making the system adaptable to various scenarios. Finally, the techniques herein incorporate security controls, such as rate limiting and group-based encryption, which helps to mitigate the risk of the system being used for DDoS attacks.

Illustratively, the techniques described herein may be performed by hardware, software, and/or firmware, (e.g., an “apparatus”) such as in accordance with the inventory management process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
forming, by a process, a dedicated multicast group comprising a plurality of network devices that support an asset discovery protocol;
receiving, by the process, a query comprising a series of descriptors corresponding to features associated with one or more network devices among the plurality of network devices;
executing, by the process, the query within the dedicated multicast group; and
generating, by the process, a report comprising specific details associated with the one or more network devices among the plurality of network devices in response to executing the query and based on the asset discovery protocol.

2. The method of claim 1, wherein the series of descriptors comprises descriptors selected for a list consisting of: security management protocols; policy compliance protocols; security assessment protocols; operational oversight protocols; safety and compliance protocols; security breach protocols; and power consumption protocols.

3. The method of claim 1, wherein the specific details in the report comprise only specific details that are relevant to the series of descriptors included in the query.

4. The method of claim 1, further comprising:
decoding, by each of the plurality of network devices that receive the query, the query; and
performing, by each of the plurality of network devices that receive the query, a local industrial asset discovery database examination as part of generating the report.

5. The method of claim 1, further comprising:
determining, by the process, that a particular network device among the plurality of network devices did not respond to the query; and
sending, by the process and to the particular network device, a unicast query to determine a status associated with the particular network device.

6. The method of claim 5, further comprising:
determining, by the process, that a response from the particular network device to the unicast query is not received; and
removing the particular network device from the dedicated multicast group in response to the response to the unicast query being not received.

7. The method of claim 5, further comprising:
determining, by the process, that a response from the particular network device to the unicast query has been received; and
maintaining the particular network device in the dedicated multicast group in response to the response to the unicast query being received.

8. The method of claim 1, further comprising:
analyzing, by the process, previously submitted queries to determine trends in reports generated in response to the previously submitted queries; and
optimizing, by the process, command distributions associated with subsequent queries based, at least in part, on analysis of the trends in the reports generated in response to the previously submitted queries.

9. The method of claim 1, wherein each network device among the plurality of network devices maintains a localized industrial asset discovery database.

10. The method of claim 1, further comprising:
generating, by the process, the report for only those network devices among the plurality of network devices that match a particular set of criteria corresponding to the series of descriptors.

11. An apparatus, comprising:
one or more network interfaces to communicate with a network;
a processor coupled to the one or more network interfaces and configured to execute one or more processes; and
a memory configured to store a process that is executable by the processor, the process comprising:
forming a dedicated multicast group comprising a plurality of network devices that support an asset discovery protocol;
receiving a query comprising a series of descriptors corresponding to features associated with one or more network devices among the plurality of network devices;
executing the query within the dedicated multicast group; and
generating a report comprising specific details associated with the one or more network devices among the plurality of network devices in response to executing the query and based on the asset discovery protocol.

12. The apparatus of claim 11, wherein the series of descriptors comprises descriptors selected for a list consisting of: security management protocols; policy compliance protocols; security assessment protocols; operational oversight protocols; safety and compliance protocols; security breach protocols; and power consumption protocols.

13. The apparatus of claim 11, wherein the specific details in the report comprise only specific details that are relevant to the series of descriptors included in the query.

14. The apparatus of claim 11, wherein the process further comprises:
decoding, by each of the plurality of network devices that receive the query, the query; and
performing, by each of the plurality of network devices that receive the query, a local industrial asset discovery database examination as part of generating the report.

15. The apparatus of claim 11, wherein the process further comprises:
determining that a particular network device among the plurality of network devices did not respond to the query; and
sending, to the particular network device, a unicast query to determine a status associated with the particular network device.

16. The apparatus of claim 15, wherein the process further comprises:
determining that a response from the particular network device to the unicast query is not received; and
removing the particular network device from the dedicated multicast group in response to the response to the unicast query being not received.

17. The apparatus of claim 15, wherein the process further comprises:
determining that a response from the particular network device to the unicast query has been received; and
maintaining the particular network device in the dedicated multicast group in response to the response to the unicast query being received.

18. The apparatus of claim 11, wherein each network device among the plurality of network devices maintains a localized industrial asset discovery database.

19. The apparatus of claim 11, wherein the process further comprises:
generating the report for only those network devices among the plurality of network devices that match a particular set of criteria corresponding to the series of descriptors.

20. A tangible, non-transitory, computer-readable medium storing program instructions that cause a device to execute a process comprising:
forming a dedicated multicast group comprising a plurality of network devices that support an asset discovery protocol;
receiving a query comprising a series of descriptors corresponding to features associated with one or more network devices among the plurality of network devices;
executing the query within the dedicated multicast group; and
generating a report comprising specific details associated with the one or more network devices among the plurality of network devices in response to executing the query and based on the asset discovery protocol.
